(19) United States
(12) Patent Application Publication
(10) Pub. No.: US 2019/0271506 A1
(43) Pub. Date: Sep. 5, 2019

(54) MODULAR OAST FLOOR PANELS AND OAST DRYING SYSTEM

(71) Applicant: Hopsharvester LLC, Honeoye Falls, NY (US)

(72) Inventors: John Bonzo, Honeoye Falls, NY (US); Jeffrey Heintz, Rochester, NY (US)

(73) Assignee: Hopsharvester LLC, Honeoye Falls, NY (US)

(21) Appl. No.: 16/290,189

(22) Filed: Mar. 1, 2019

Related U.S. Application Data
(60) Provisional application No. 62/637,862, filed on Mar. 2, 2018.

(51) Int. Cl. F26B 9/06; C12C 1/12; F26B 3/06; F26B 15/08; F26B 25/00; F26B 25/18

(52) U.S. Cl. CPC F26B 9/066; C12C 1/12; F26B 3/06; F26B 2200/06; F26B 25/001; F26B 25/18; F26B 15/08

(57) ABSTRACT

A modular oast floor panel and an oast drying system is disclosed, particularly for use in drying agricultural crops such as herbs, hops and the like.

This application claims priority under 35 U.S.C. § 119(e) from U.S. Provisional Patent Application No. 63/637,862 for a MODULAR OAST FLOOR PANELS & OAST DRYING SYSTEM, by J. Bonzo et al., filed Mar. 2, 2018, which is hereby incorporated by reference in its entirety.

Disclosed are embodiments of a modular oast floor panel and an oast drying system for use in drying agricultural crops and the like. Several disclosed embodiments are also suitable for automated control.

### BACKGROUND AND SUMMARY

Drying hops, forage and other agricultural products (e.g., herbs, cannabis) effectively is a challenge for most farming operations. The modular system disclosed is a scalable solution for increasing drying capacity to meet annual production demand, and may be configured to dry small or large batches while conserving floor space. Each floor panel includes gates (e.g., “trap-door” style gates) that help mix the materials passing through, which results in uniform moisture-content when indexing agricultural product from one level to the next. The gates eliminate the need for repeated positioning of shelves and bins and the raking or agitation required by other drying methods.

As the various embodiments described below will demonstrate, the modular components are simple to scale and permit the building and customization of an oast drying system. Such a system may be designed and built in a modular fashion, allowing for the addition of modules as additional capacity is required. Moreover, the modular floor panels may be sized so as to work with conventional US lumber dimension. Heaters and blowers or various types may be added as needed. Use of a vertical oast design is also useful in eliminating bottlenecks by providing a continuous drying process as well as achieving a more homogeneous moisture content.

Additional embodiments may also include monitoring and automation of various steps. For example, sensors may be employed in order to characterize the moisture content of the agricultural product being dried in the oast. Further embodiments provide controls to automate the drying process, particularly the transfer or indexing of the agricultural product from one level to the next until dried to the desired level.

Disclosed in embodiments herein is a modular agricultural product drying panel comprising: a rectangular frame defining at least a perimeter of the product drying panel, where at least a portion of the frame is downwardly angled to prevent the retention of agricultural product thereon; a plurality of perforated rectangular gates, each of the gates being pivotally connected to the frame at opposite ends, the gates further including a downward extending position control member having a connecting feature at the bottom; and an actuator arm pivotally connected to the connecting feature of each of the gates, whereby movement of the actuator arm in a direction generally perpendicular to longitudinal axes of the gates concurrently controls a tilt position of the plurality of gates, wherein the tilt position may be varied between a horizontal position and downwardly-tilted position suitable to allow the agricultural product to pass through the drying panel.

Further disclosed in embodiments herein is an agricultural product drying system comprising: a) a drying chamber having a plurality of drying surfaces therein; b) each of said drying surfaces including at least one modular drying panel for the support of the agricultural product thereon, each modular drying panel being operable to pass dried agricultural product through said panel into a space below; and c) a source of a drying gas for discharge through said plurality of drying surfaces.

Also disclosed herein is an automated agricultural product drying system, comprising: a) a drying chamber having a plurality of drying surfaces therein; b) each of said drying surfaces including at least one modular drying panel for the support of the agricultural product thereon, each modular drying panel being operable to pass dried agricultural product through said panel into a space below; c) a source of a drying gas for discharge through said plurality of drying surfaces; and d) a programmable control system for receiving inputs from at least one sensor and controlling operation of the drying system, including the movement of agricultural product through the system.

### BRIEF DESCRIPTION OF THE DRAWINGS

FIG. 1 is an illustrative example of a modular oast drying panel for drying an agricultural product;

FIG. 2 is an illustrative, partial view of an exemplary agricultural product drying system incorporating modular oast drying panels such as depicted in FIG. 1;

FIGS. 3-5 are illustrative drawings of an alternative embodiment of a modular oast drying panel;

FIGS. 6A-6B are, respectively, full-size and expanded illustrations of an alternative drying rack system incorporating the modular panels of FIGS. 3-5;

FIG. 7 is an exemplary representation of an oast drying system employing modular oast drying panels in accordance with an alternative embodiment;

FIG. 8 is an illustration of the operation of an oast drying system similar to the embodiment of FIG. 7;

FIG. 9 is an illustration of an exemplary drying gas (air) source in accordance with an exemplary embodiment of the oast of FIGS. 7-8 and 10;

FIG. 10 is a schematic diagram depicting components for use in an automated drying system in accordance with an alternative embodiment; and

FIGS. 11A-111 are illustrative drawings for the assembly of a multi-level drying oast, including components selected for conventional US lumber sizes.

The various embodiments described herein are not intended to limit the disclosure to those embodiments described. On the contrary, the intent is to cover all alternatives, modifications, and equivalents as may be included within the spirit and scope of the various embodiments and equivalents set forth. For a general understanding, reference is made to the drawings. In the drawings, like references have been used throughout to designate identical or similar elements. It is also noted that the drawings may not have been drawn to scale and that certain regions may have been purposely drawn disproportionately so that the features and aspects could be properly depicted.

### DETAILED DESCRIPTION

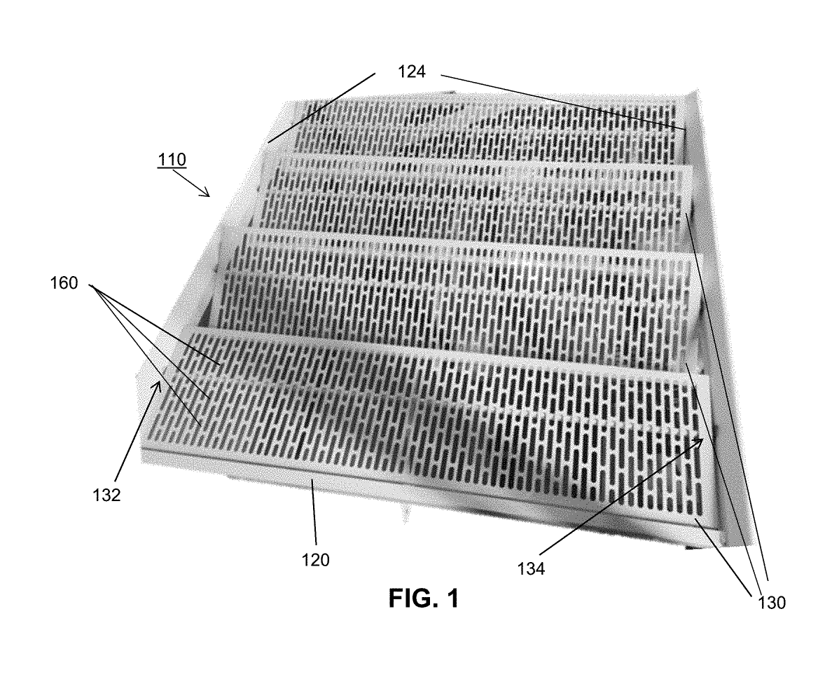

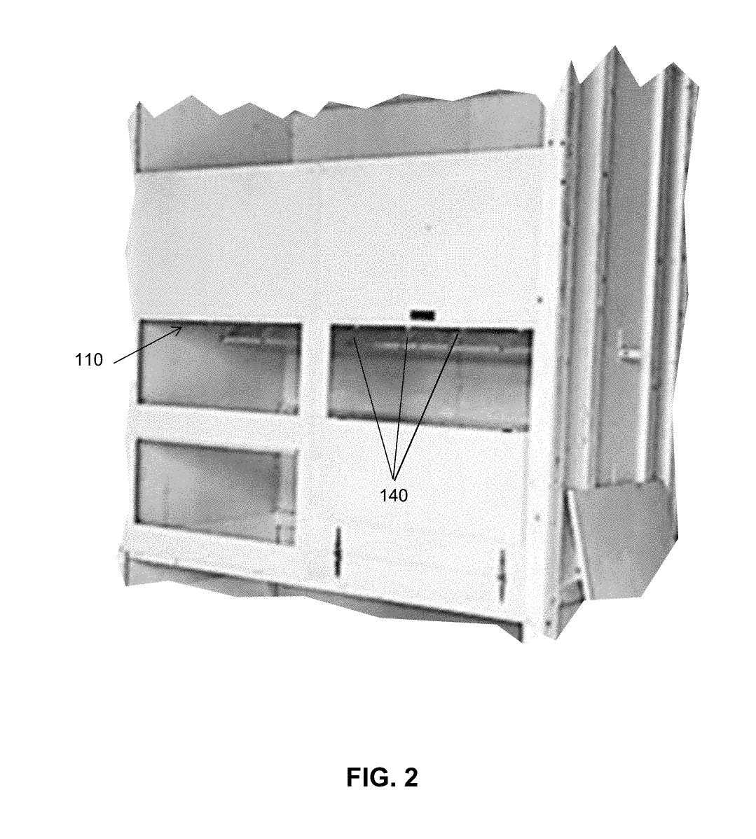

Referring to the figures, this disclosure uses the term “oast” interchangeably to refer to a drying system suitable for drying agricultural products including hops, herbs (e.g., cannabis), forage and the like. One feature of the disclosed oast embodiments is a modular agricultural product drying panel 110 as depicted in FIG. 1. The drying panel 110 includes, among other components, a rectangular frame 120 defining at least a perimeter of the product drying panel. At least a portion (e.g., side rails 124) of the frame is downwardly angled to assist in the flow of the material being dried and to prevent the retention of agricultural product on the frame. Within and supported by the frame are a plurality of perforated rectangular grates or gates 130, each of the gates being pivotally connected to the frame at opposite ends 132 and 134. As illustrated in other figures, the gates 130 further include a downward extending position control member 140 having a connecting feature such as a hole 142 with a pin or similar pivoting linkage at the bottom. And, an actuator arm 150 is pivotally connected to the connecting feature of each of the gates, whereby movement of the actuator arm in a direction generally perpendicular to longitudinal axes of the gates (arrow 154) controls the tilt position of all of the gates 130 that are conjoined by the actuator arm. Thus, the tilt position of the gates 130 may be varied between a horizontal or flat position that will retain the agricultural produce on the gate, and downwardly-tilted position, like an open trap door, suitable to allow the agricultural product to pass through the drying panel 110.

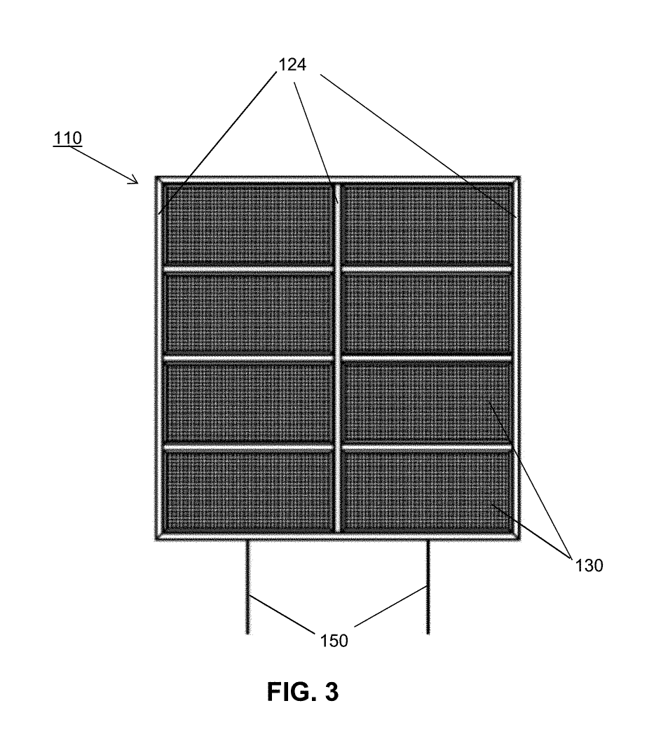

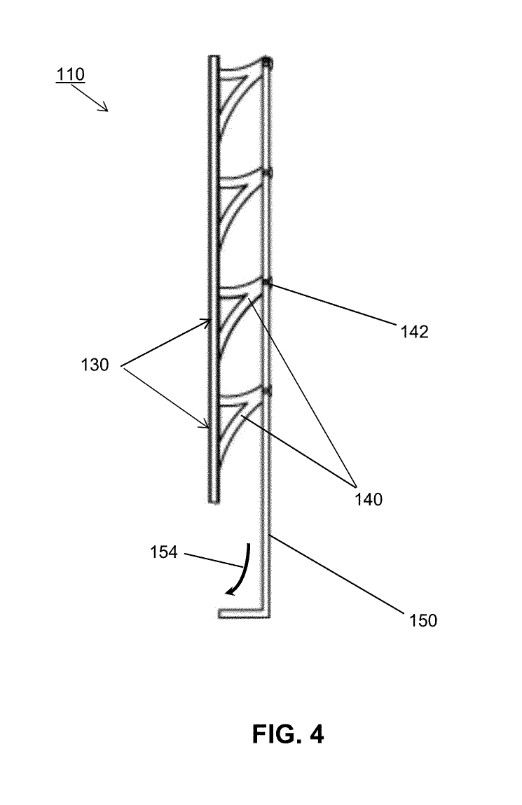

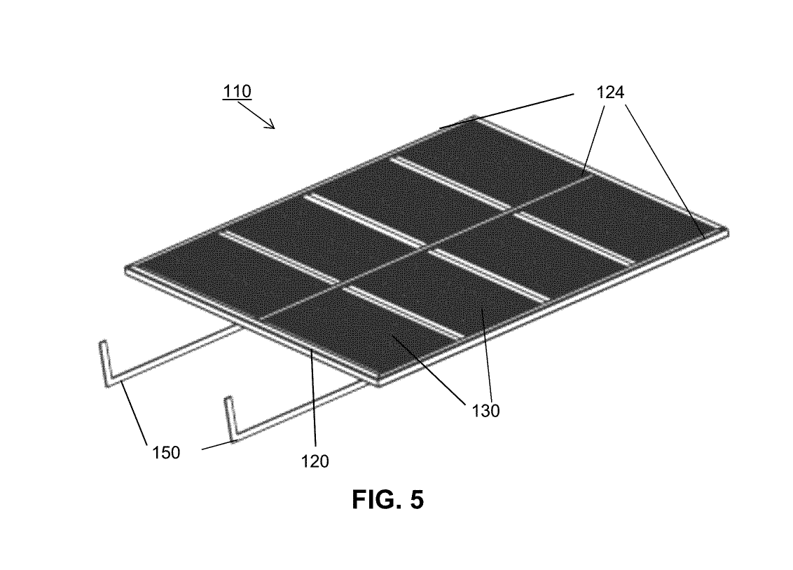

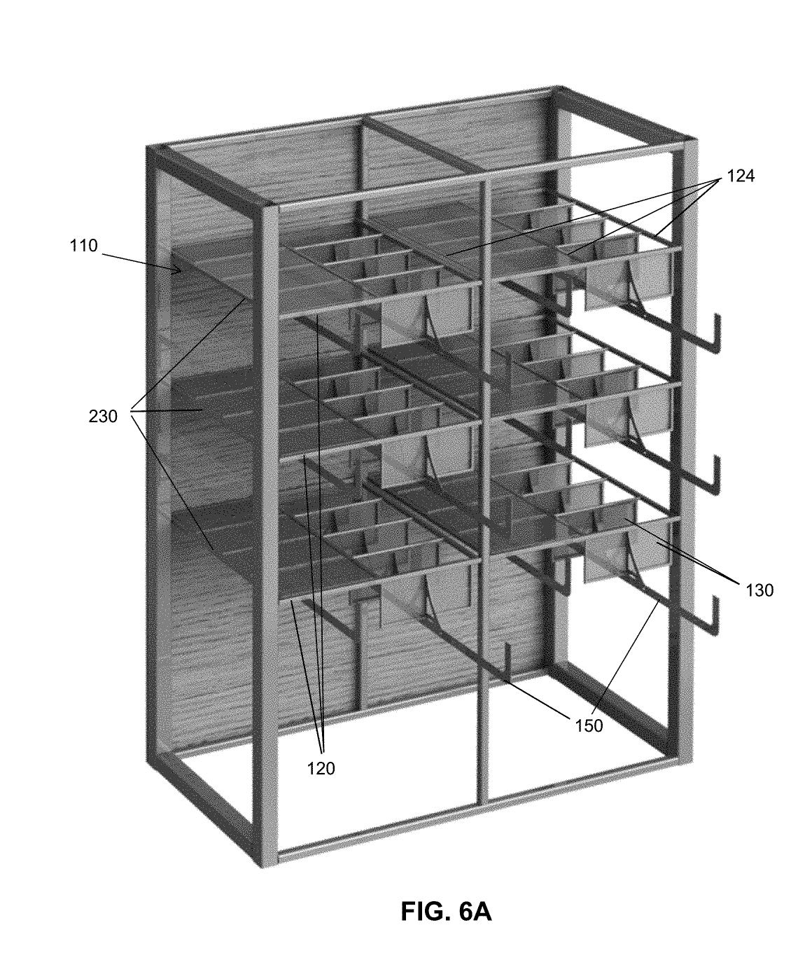

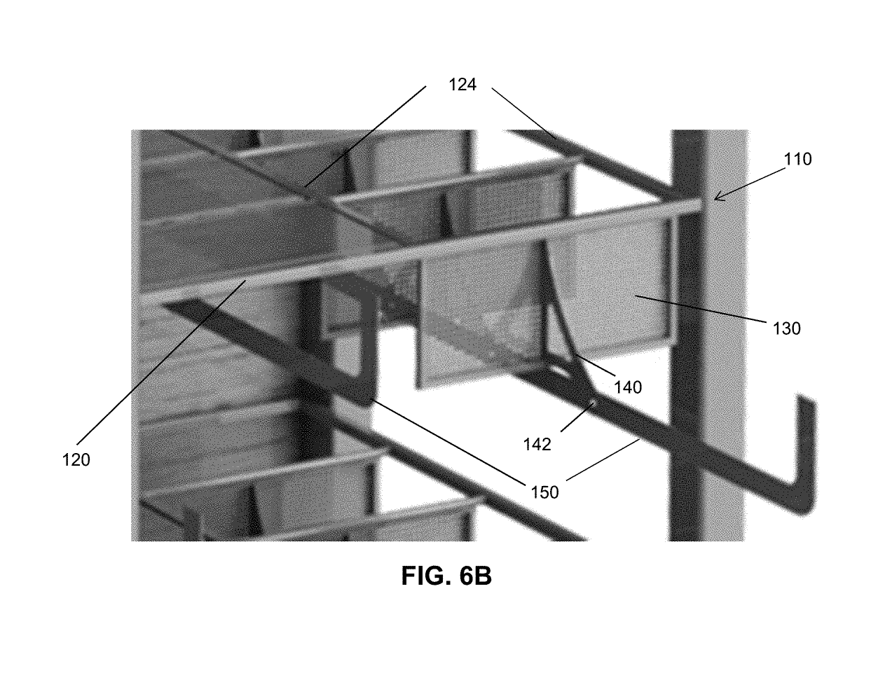

In each of the embodiments, gates 130 are pivotally connected to the frame so as to pivot at a side edge of each gate, where the edge is adjacent the side rail of the frame. As illustrated in FIG. 1, the modular panel has gates that are pivotally connected so as to pivot about an axis located between the longitudinal edge and the center of each gate. In the configuration of FIG. 1, when tilted a portion of the gate is above the pivot axis and rotates above the frame whereas the balance of the gate is below the pivot axis and rotates below the frame. Such a configuration, with the pivot axis on or near a centerline of the gate minimizes head space required between the levels or shelves. In an alternative embodiment of the modular oast panel the gates of FIGS. 3-6B are pivotally connected near the longitudinal edge of the gate, so that the entire gate swings downward like a trap door. Furthermore, the embodiment depicted in FIGS. 6A-6B illustrates the relative positions of the gates 130 and actuator arms 150 for the leftmost gates in each panel that are in a horizontal (drying) position versus the rightmost gates that are in a tilted (discharge or dumping) position.

As will be appreciated, in the various drying panel embodiments, each of said gates has a non-perforated border, with an interior that is perforated to permit the flow of a drying gas such as heated air to pass through the gate and through the agricultural material supported by the gate. In FIG. 1, for example, the perforation pattern of gates 130 includes rows of elongated slots 160 where the slots of adjacent rows are offset from one another to avoid a non-perforated region spanning a plurality of rows and creating a blockage to gas flow. Furthermore, the top surface of each gate is generally flat or planar, without any portion extending upward (outward) in order to avoid retaining any agricultural product when the gate is tilted. And, while the panels 110 may be made in various sizes and rectangular or other custom shapes, in one embodiment the panel dimensions as seen in FIGS. 3-5, are intentionally sized to permit the balance of the oast to be made using conventional US lumber sizes with a minimum of cutting. For example, the panel may be sized to fit within a chamber constructed of conventional 4′×8′ plywood dimensions.

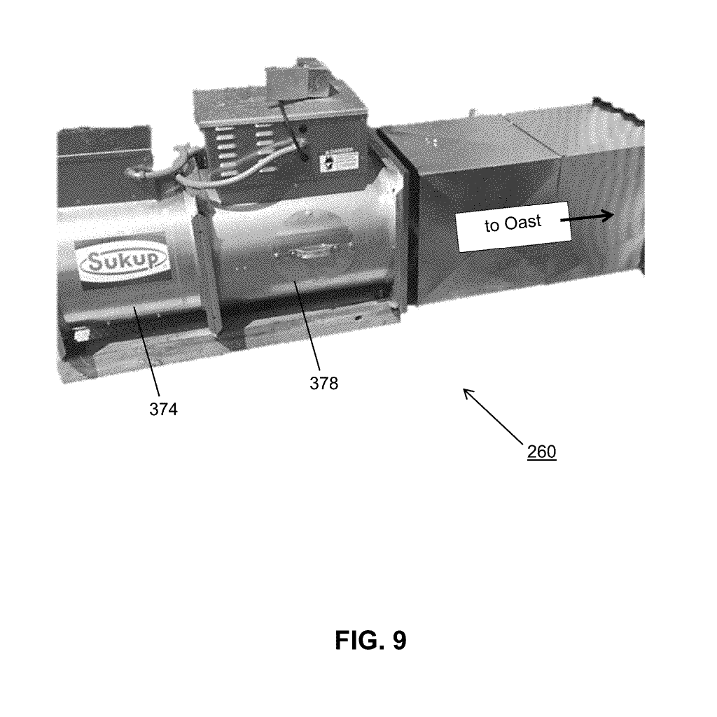

Having described features of the modular panel embodiments, attention is now turned to an embodiment for an agricultural product drying system 210. System 210 includes a drying chamber or housing 220 having a plurality of drying levels or surfaces 230. Each of the drying surfaces 230 includes at least one modular drying panel 110 for the support of the agricultural product thereon, and each modular drying panel is operable to tilt the gates 130 and pass dried agricultural product through the panel to a surface or space below. The system also includes a source of a drying gas 260 such as depicted in FIG. 9, where the drying gas, such as heated or conditioned (e.g., dehumidified) air, is applied to a lower chamber or plenum of the housing 220 for upward discharge through the plurality of drying levels or surfaces. It is possible, however, to employ ducting or other techniques by which the drying gas is applied at the top and/or other locations within the oast housing, and the location(s) at which the drying gas is applied is not intended as a limitation. Also contemplated is the use of a fan or similar device suitable to pull drying gas or air through one or more levels of the system 210.

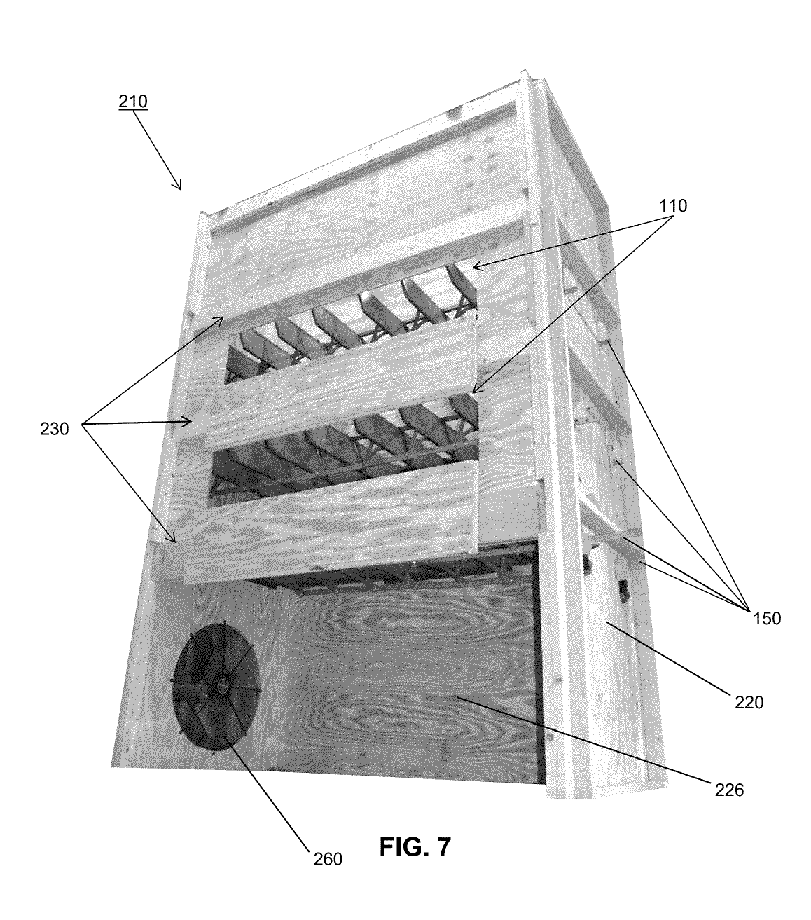

As will be appreciated from FIGS. 3-8, the system 210 has horizontal drying surfaces oriented to at least partially overlap one another vertically. A stacked or aligned vertical configuration of FIG. 7, for example, with each drying surface directly over the other, is believed to be an efficient use of floor space for drying of the agricultural material. The source of drying gas 260 may be attached to a plenum box 226 located beneath a lowest drying surface, wherein dried agricultural product may also be collected in the plenum box using a collection tray, cloth or similar means that fits within the plenum box.

As illustrated, in drying system 210, each of the three drying surfaces 230 includes at least one modular drying panel 110, (two are used at each level) and the modular drying panel is constructed in a manner as described in the various embodiments above. Moreover, in embodiments that employ more than a single drying panel 110 at each drying surface or level, the panels may be daisy-chained to one another so that gates in all of the panels may be operated concurrently to control or move the gates to the flat or tilted position. And, as an alternative, it is also possible to orient the panels in such a way so that each panel's actuator arm(s) 150 is independently controllable and does not impact another panel at the same level.

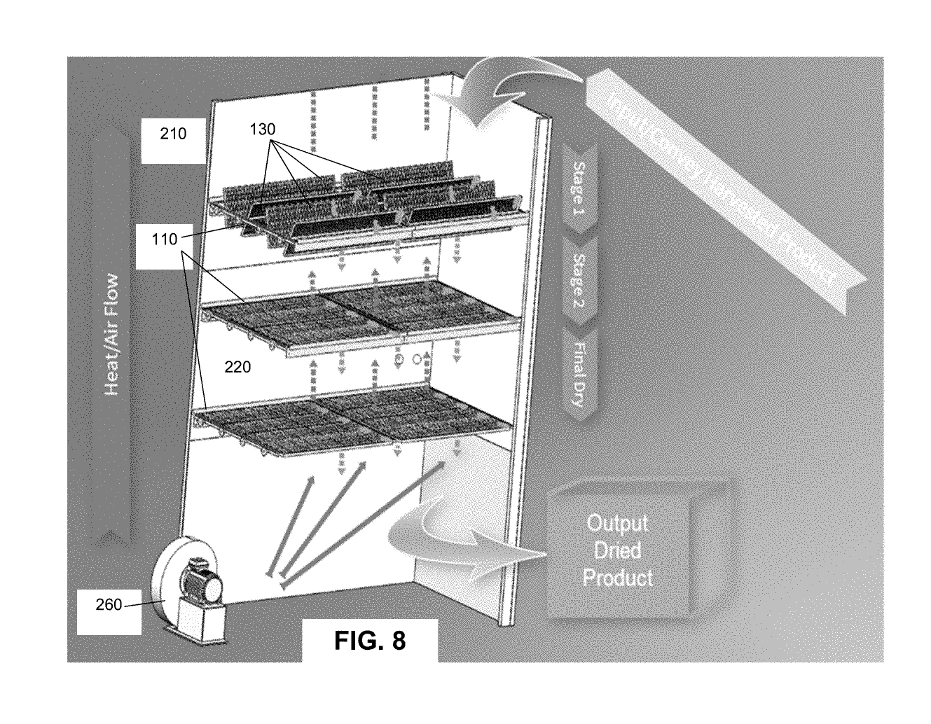

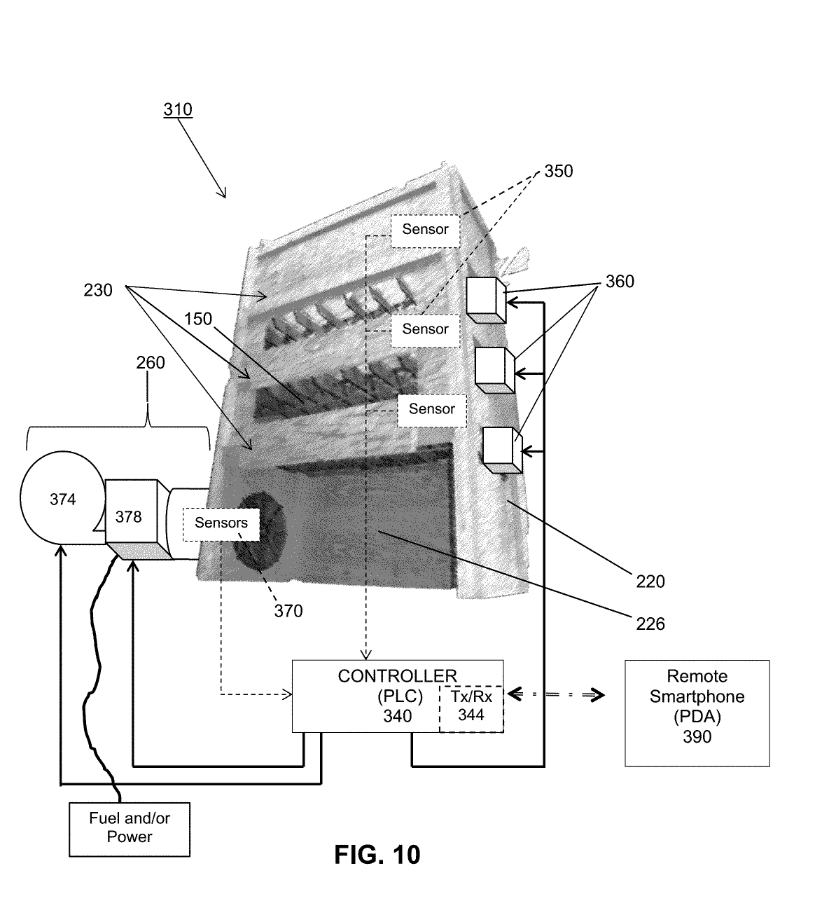

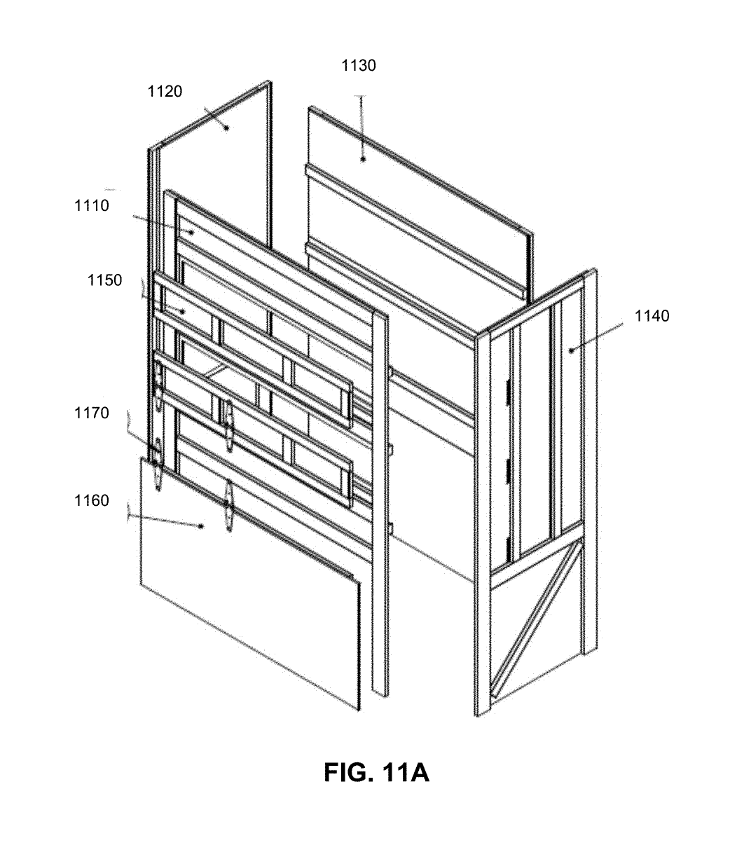

Considering FIG. 8, along with FIGS. 9-10, depicted therein is an automated agricultural product drying system 210, which includes a drying chamber 220 having a plurality of drying surfaces therein. Each of the drying surfaces further includes at least one modular drying panel 110 for the support of the agricultural product to be dried thereon, each modular drying panel being operable to pass dried agricultural product through said panel (e.g., see top panel with tilted gates or surfaces 130) into a space below. In the prior embodiments the panels include surfaces 130 that pivot so as to tip and allow the material on the upper surface to pass to a lower surface in the oast. In the embodiments the gates 130 may all tip in the same direction, or, as depicted in FIG. 8, adjacent pairs of gates 130 may tip toward or away-from one another.

System 210 also includes a source of a drying gas 260 supplying, for example, heated air at the bottom of the oast for discharge through the plurality of drying surfaces. Moreover, as further depicted in FIG. 10 for example, the drying system's operation may be controlled via a programmable control system 340 for receiving inputs from at least one sensor(s) 350, 370 and controlling operation of the drying system, including the movement of agricultural product through the system. The programmable control system includes a controller for receiving signals and executing a set of pre-programmed instructions to control operation.

At least one sensor 350 is suitable for characterizing the moisture content of the agricultural product in the oast (e.g., at one or more of the drying surfaces. For example, the sensor may include a plurality of load cells, a first set of load cells for determining a first weight of the agricultural product introduced on an uppermost drying surface and a second set of load cells for determining a second weight of the agricultural product on a lowermost drying surface, and based upon the differential between the first weight and the second weight, determining when the lowermost agricultural product has reached a desired moisture content. If the desired moisture content is determined to be present the system, under programmatic control, automatically passes the lowermost agricultural product through the lowermost drying surface, and subsequently indexes each of the remaining drying surfaces above to move remaining agricultural product to a next-lower surface for continued drying.

As will be appreciated based upon the disclosure presented herein relative to the automation of the panels 110 and gates 130, the automated drying system is capable of automatically passing agricultural product through a drying surface using an electro-mechanical actuator, operatively connected to an actuator arm associated with the drying surface. Thus, the electro-mechanical actuator being operable under the control of said programmable control system to pass the product through stage 1 to stage 2 and to the final dry stage before the dried product is ready for discharge. As will be further appreciated, the programmable control of drying system 210 is also suitable for controlling at least one of a gas temperature and a gas volume produced by source of drying gas 260. Moreover, to facilitate automation of a plurality of such oast-type drying systems, the disclosed embodiment further the programmable control system including a transceiver (240) for sending notification of the system status to a remote device such as a workstation or networked computer that is capable to monitoring and/or controlling operation of each drying system.

Attention is now directed to FIG. 10, which depicts an automated embodiment of the oast drying system employing components such as those described above. Automated agricultural product drying system 310 also includes a drying chamber 220 having a plurality of drying surfaces 230 as described relative to FIG. 7. Each of the drying surfaces 230 includes a pair of 4′×4′ modular drying panels for the support of the agricultural product and are operable via an actuator arm(s) 150 to pass dried agricultural product through the panel into a space below. As illustrated the drying gas source 260 is positioned in this embodiment for discharge upward through three drying surfaces 230. A programmable control system 340, such as a programmable logic controller (PLC) or similar device, is provided for receiving inputs from at least one sensor and controlling operation of the drying system, including the indexed movement of agricultural product through the system one level at a time (e.g., the discharge of a level requires that the level below has been previously discharged and the gates of the panel returned to a horizontal position).

As will be appreciated, the programmable control system 340 is suitable for receiving signals and executing a set of pre-programmed instructions. The received signals may include one or more sensor outputs, where the sensors 350 provide an indication of information such as moisture content of the agricultural material at one or more levels of the drying system. Such sensors may be contact-type sensors that are placed within the agricultural product mass at each level, or they may be humidity sensors sensing the humidity level of the drying gas that has passed through the product at each level. In an alternative embodiment contemplated, instead of or in addition to moisture sensors, the characterization of the moisture content of the agricultural product may be accomplished using a plurality of load cells. A first set of load cells is placed beneath the frame 120 of drying panels 110 for determining a first weight of the agricultural product introduced on the uppermost (top) drying surface 230, and a second set of load cells is similarly used for determining a second weight of the agricultural product on at least the lowermost (bottom) drying surface 230. Once the load cell information is accumulated from each of the two levels, and based upon the differential between the calculated first (top) weight and the second (bottom) weight, determining when the lowermost agricultural product has reached a desired moisture content by the total amount of weight lost or percentage of weight lost by the material since it was introduced at the topmost level. When the bottommost material is sufficiently dried, it is then automatically passed through the lowermost drying surface to a collection container (not shown) in plenum box 226. Subsequently each of the remaining drying surfaces above are indexed to move remaining agricultural product on each level to a next-lower surface for continued drying.

Furthermore, automatically passing agricultural product through each drying surface may be accomplished using an electro-mechanical actuator 360, operatively connected to an actuator arm(s) 150 associated with the drying surfaces, the electro-mechanical actuator(s) being operable under the control of and in response to the programmable control system. More specifically, the electro-mechanical actuator 360 may include a single drive sprocket and a plurality (e.g., four) slave sprockets operatively attached thereto. For example, in one embodiment the slave sprockets and drive sprocket may be connected via a common drive shaft. It will be appreciated that the drive sprocket may be motor-driven, or it could be manually operated. In any event, movement of the drive sprocket results in movement of the slave sprockets and driving of all of the gates of the drying panel 110. The actuators may include solenoids or motors mounted on the side of housing 220 and operatively connected or linked to an end of the actuator arms 150. Also contemplated is the use of the programmable control system for controlling at least one of the input drying gas temperature and the drying gas volume produced by the source of drying gas. As will be appreciated, the temperature and volume (e.g., flow rate) of the draying gas may be monitored by one or more sensors 370, and the controller may similarly control or adjust the outputs of the blower 374 and/or heat source 378 (e.g., electric or LP heater) to obtain the desired characteristics for the drying gas.

The use of a controller 340 further enables the potential for communication (wired or wireless via transceiver 344) with a remote computer, smart phone or similar personal digital assistance (PDA) device 390 so that a user can query the status of the drying system and/or automatically receive updates as to status or out-of-spec operation. It is further conceivable that the user may remotely control one or more of the operations of the drying system via the PDA 390.

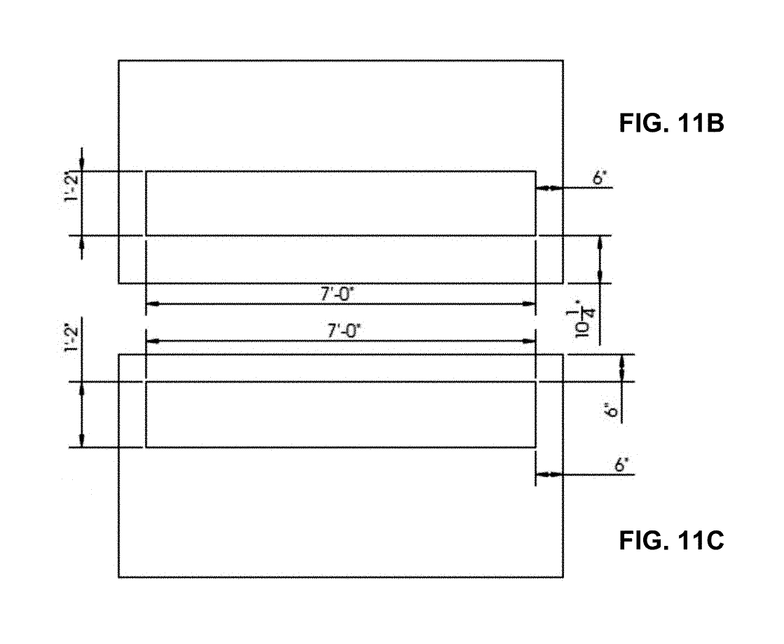

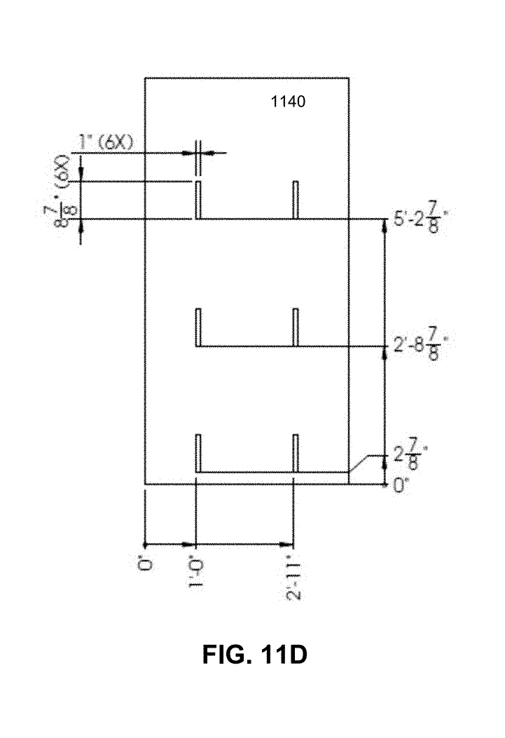

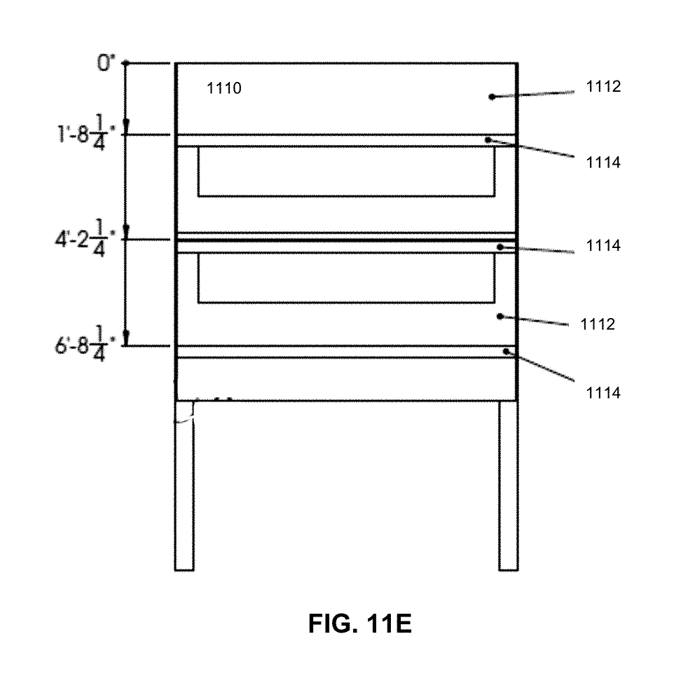

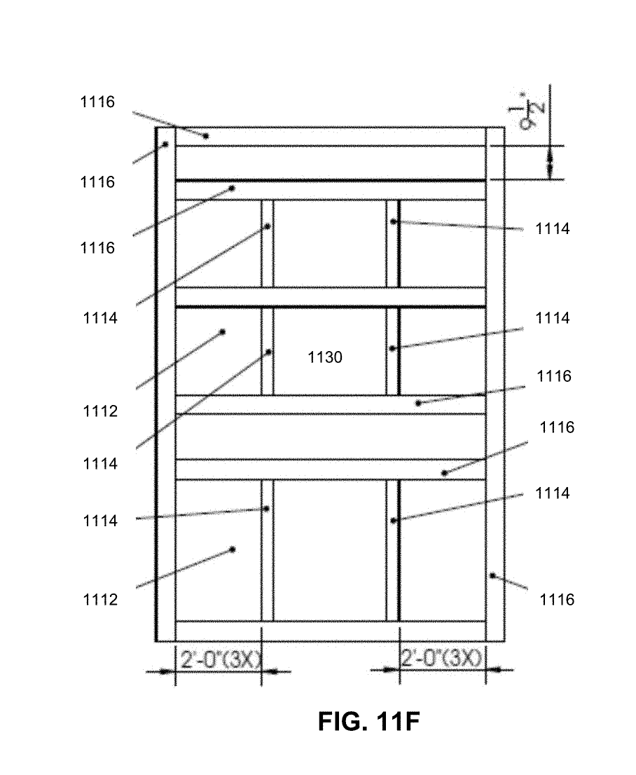

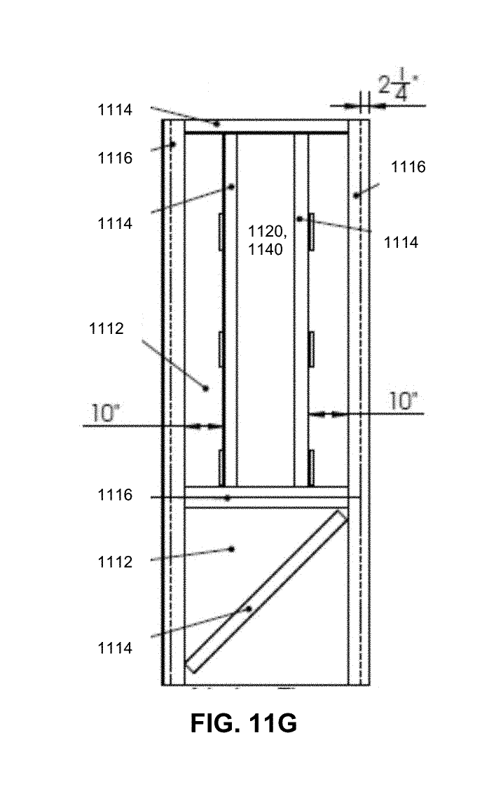

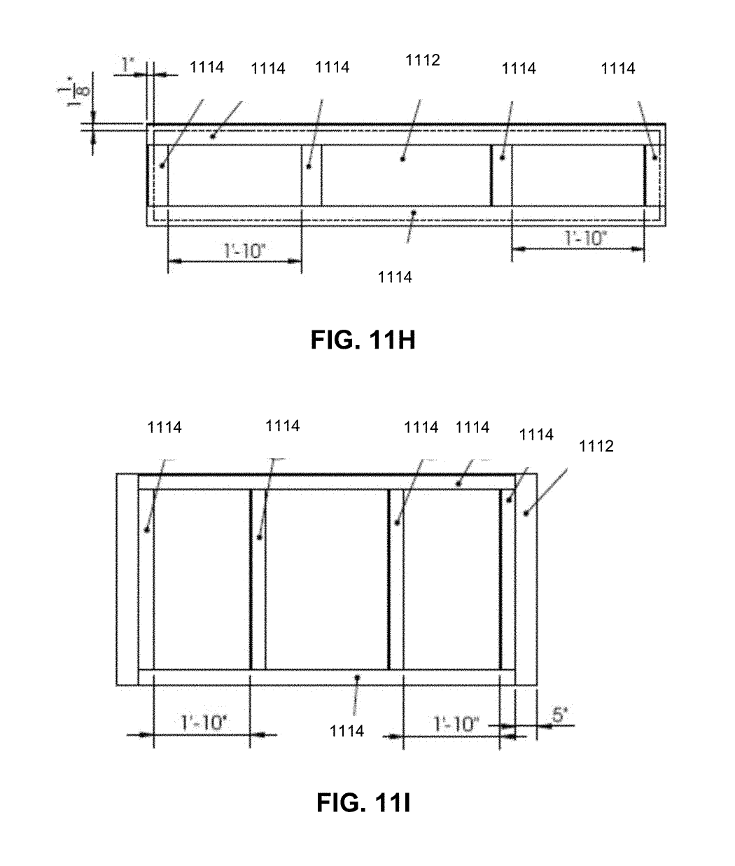

For purposes of illustration, FIGS. 11A-11I are provided as illustrative part and assembly drawings for assembly of an exemplary multi-level drying system or oast, including components selected for conventional US lumber sizes, including conventional 2×framing lumber and plywood sheeting (e.g., 4′×8′×¾″). FIG. 11A is an assembly-level drawing depicting the following: front 1110, left side 1120, back 1130, right side 1140, tier door 1150, bottom door 1160 and hinge assemblies 1170. FIGS. 11B-11C are illustrations, respectively, of the front and front-bottom portions, with exemplary dimensions shown (all measurements in feet-inches). FIG. 11D is an illustration of the construction of the side (e.g. side 1140; also see FIG. 11G). FIG. 11E is an illustration of several dimensions and construction of front 1110, made with sheets of plywood 1112, 2×4s 1114. Similarly, FIG. 11F is an illustration of the dimensions and construction of back 1130, made with sheets of plywood 1112, 2×4s 1114 and 2×6's 1116. FIG. 11G is an exemplary illustration of the dimensions and construction of side 1120 or 1140 (1140 having slotted holes pursuant to FIG. 11D), and is similarly made with sheets of plywood 1112, 2×4s 1114 and 2×6's 1116. Finally, FIGS. 11H-11I are exemplary illustrations of the dimensions and construction of doors 1150 and 1160, respectively, made with sheets of plywood 1112 and 2×4s 1114. It will be appreciated that alternative configurations and sizing may be employed to achieve a drying system suitable for one or more agricultural products. For example, leafy or less dense agricultural product may require more or less drying area than dense product, and some agricultural product may need to be maintained in a one or a limited few layers on each tier, whereas other products may be dried in a large volume (e.g., multiple layers of product) on each tier.

It should be understood that various changes and modifications to the embodiments described herein will be apparent to those skilled in the art. Such changes and modifications can be made without departing from the spirit and scope of the present disclosure and without diminishing its intended advantages. It is therefore anticipated that all such changes and modifications be covered by the instant application.

What is claimed is:

1. A modular agricultural product drying panel comprising:
a rectangular frame defining at least a perimeter of the product drying panel, where at least a portion of the frame is downwardly angled to prevent the retention of agricultural product thereon;
a plurality of perforated rectangular gates, each of the gates being pivotally connected to the frame at opposite ends, the gates further including a downward extending position control member having a connecting feature at the bottom; and
an actuator arm pivotally connected to the connecting feature of each of the gates, whereby movement of the actuator arm in a direction generally perpendicular to longitudinal axes of the gates concurrently controls a tilt position of the plurality of gates, wherein the tilt position may be varied between a horizontal position and downwardly-tilted position suitable to allow the agricultural product to pass through the drying panel.

2. The drying panel according to claim 1, wherein said gates are pivotally connected so as to pivot about a longitudinal edge of each gate.

3. The drying panel according to claim 1, wherein said gates are pivotally connected so as to pivot about an axis spaced apart from the longitudinal edge and toward the center of each gate.

4. The drying panel according to claim 1, wherein each of said gates has a non-perforated border.

5. The drying panel according to claim 1, wherein the perforation pattern of said gates includes rows of elongated slots where the slots of adjacent rows are offset from one another to avoid a non-perforated region spanning a plurality of rows.

6. The drying panel according to claim 1, wherein the top surface of each gate is generally planar to avoid retaining the agricultural product when the gate is tilted.

7. The drying panel according to claim 1, wherein the panel is sized to fit within a chamber constructed of conventional plywood dimensions.

8. An agricultural product drying system comprising:
a) a drying chamber having a plurality of drying surfaces therein;
b) each of said drying surfaces including at least one modular drying panel for the support of the agricultural product thereon, each modular drying panel being operable to pass dried agricultural product through said panel into a space below; and
c) a source of a drying gas for discharge through said plurality of drying surfaces.

9. The system according to claim 8, wherein said drying surfaces are oriented so as to at least vertically overlap one another.

10. The system according to claim 8, wherein said source of drying gas is attached to the drying chamber.

11. The system according to claim 10, wherein said source of drying gas is attached to a plenum box within the drying chamber located beneath a lowest drying surface where dried agricultural product may be collected in the plenum box, or above an uppermost drying surface.

12. The system according to claim 8, wherein each of the drying surfaces includes at least one modular drying panel.

13. The system according to claim 12, wherein the modular drying panel comprises:
a rectangular frame defining at least a perimeter of the product drying panel, where at least a portion of the frame is downwardly angled to prevent the retention of agricultural product thereon;
a plurality of perforated rectangular gates, each of the gates being pivotally connected to the frame at opposite ends, the gates further including a downward extending position control member having a connecting feature at the bottom;
an actuator arm pivotally connected to the connecting feature of each of the gates, whereby movement of the actuator arm in a direction generally perpendicular to longitudinal axes of the gates concurrently controls a tilt position of the plurality of gates, wherein the tilt position may be varied between a horizontal position and downwardly-tilted position suitable to allow the agricultural product to pass through the drying panel.

14. The system according to claim 12, wherein said gates are pivotally connected so as to pivot about a longitudinal edge of each gate.

15. The system according to claim 12, wherein said gates are pivotally connected so as to pivot about an axis located between the longitudinal edge and the center of each gate.

16. The system according to claim 12, wherein each of said gates has a non-perforated border.

17. The system according to claim 12, wherein the perforation pattern of said gates includes rows of elongated slots where the slots of adjacent rows are offset from one another to avoid a non-perforated region spanning a plurality of rows.

18. The system according to claim 12, wherein the top surface of each gate is generally planar to avoid retaining the agricultural product when the gate is tilted.

19. The system according to claim 12, wherein each drying surface is comprised of a plurality of drying panels daisy-chained to one another to permit concurrent activation of each of the modules.

20. An automated agricultural product drying system, comprising:
a) a drying chamber having a plurality of drying surfaces therein;
b) each of said drying surfaces including at least one modular drying panel for the support of the agricultural product thereon, each modular drying panel being operable to pass dried agricultural product through said panel into a space below;
c) a source of a drying gas for discharge through said plurality of drying surfaces; and
d) a programmable control system for receiving inputs from at least one sensor and controlling operation of the drying system, including the movement of agricultural product through the system.
